(19) United States
(12) Patent Application Publication
(10) Pub. No.: US 2017/0046613 A1
(43) Pub. Date: Feb. 16, 2017

(54) SYSTEMS AND METHODS FOR CONTENT CLASSIFICATION AND DETECTION USING CONVOLUTIONAL NEURAL NETWORKS

(71) Applicant: Facebook, Inc., Menlo Park, CA (US)

(72) Inventors: Balamanohar Paluri, Menlo Park, CA (US); Lubomir Bourdev, Mountain View, CA (US); Ronan Stéfan Collobert, Los Altos, CA (US); Chen Sun, Los Angeles, CA (US)

(21) Appl. No.: 15/091,490

(22) Filed: Apr. 5, 2016

Related U.S. Application Data
(60) Provisional application No. 62/203,011, filed on Aug. 10, 2015.

(51) Int. Cl. G06N 3/04; G06N 3/08

(52) U.S. Cl. CPC G06N 3/0445; G06N 3/08

(57) ABSTRACT

Systems, methods, and non-transitory computer-readable media can obtain a content item to be evaluated by a set of cascaded convolutional neural networks, the set of cascaded convolutional neural networks including at least a first convolutional neural network (CNN) and a second CNN. The content item can be provided to the first CNN as input, wherein an output of the first CNN includes data describing at least one region of interest in the content item and at least one first concept corresponding to the region of interest. The output of the first CNN can be provided to the second CNN as input, wherein an output of the second CNN includes data describing at least one second concept corresponding to the region of interest, the second concept being more accurate than the first concept.

### CROSS-REFERENCE TO RELATED APPLICATIONS

This application claims the benefit of U.S. Provisional Application No. 62/203,011, filed on Aug. 10, 2015, which is hereby incorporated herein by reference in its entirety.

### FIELD OF THE INVENTION

The present technology relates to the field of content classification and detection. More particularly, the present technology relates to techniques for classifying and detecting content using convolutional neural networks.

### BACKGROUND

Today, people often utilize computing devices for a wide variety of purposes. Users can use their computing devices, for example, to communicate and otherwise interact with other users. Such interactions are increasingly popular through a social network.

Some interactions in a social networking system may include the sharing of content. Content can be shared in a variety of manners. One example of a technique to share content with a user of a social networking system is by posting content items (i.e., posts). Such content items can include, for example, media files such as images and/or videos uploaded to the social networking system by users. In one example, posted content items can be presented through respective content feeds (e.g., news feeds) of other users of the social networking system.

In some instances, it may be advantageous to evaluate and classify concepts (e.g., scenes, objects, actions, etc.) that are represented in each of the uploaded content items. In one example, an uploaded content item that has been classified as inappropriate can be flagged and be prevented from being shared through the social networking system. Conventional approaches for recognizing concepts represented in content items can often times be inefficient, inaccurate, and/or be limited in capability.

### SUMMARY

Various embodiments of the present disclosure can include systems, methods, and non-transitory computer readable media configured to obtain a content item to be evaluated by a set of cascaded convolutional neural networks, the set of cascaded convolutional neural networks including at least a first convolutional neural network (CNN) and a second CNN. The content item can be provided to the first CNN as input, the first CNN including at least one convolutional layer, pooling layer, and fully-connected layer, wherein an output of the first CNN includes data describing at least one region of interest in the content item and at least one first concept corresponding to the region of interest. The output of the first CNN can be provided to the second CNN as input, the second CNN including at least one convolutional layer, pooling layer, and fully-connected layer, wherein an output of the second CNN includes data describing at least one second concept corresponding to the region of interest, the second concept being more accurate than the first concept.

In an embodiment, the systems, methods, and non-transitory computer readable media are configured to cause the first CNN to be trained using at least a set of annotated training examples, wherein a training example includes a content item and at least one label for the content item that identifies (i) a concept captured in the content item and (ii) a location corresponding to the concept in the content item.

In an embodiment, the systems, methods, and non-transitory computer readable media are configured to cause the second CNN to be trained using at least some outputs that were produced by the first CNN.

In an embodiment, the systems, methods, and non-transitory computer readable media are configured to provide a zoomed-in portion of the at least one region of interest to the second CNN.

In an embodiment, the output of the second CNN includes data describing at least one second region of interest in the content item and at least one concept corresponding to the second region of interest.

In an embodiment, the systems, methods, and non-transitory computer readable media are configured to provide the output of the second CNN to a third CNN as input, the third CNN including at least one convolutional layer, pooling layer, and fully-connected layer, wherein an output of the third CNN includes information describing at least one third concept corresponding to the region of interest, the third concept being more accurate than the second concept.

In an embodiment, the systems, methods, and non-transitory computer readable media are configured to determine that a user of a social networking system that is associated with the content item satisfies one or more criteria.

In an embodiment, the output of the second CNN further includes location information corresponding to the second concept.

In an embodiment, the location information includes at least one of a heat map, pixel coordinates, or bounding region.

In an embodiment, the at least one second concept corresponds to a scene, item, object, motion, or action represented in the content item.

### BRIEF DESCRIPTION OF THE DRAWINGS

FIG. 1 illustrates an example of a cascaded convolutional neural network, according to an embodiment of the present disclosure.

FIG. 2 illustrates another example of a cascaded convolutional neural network, according to an embodiment of the present disclosure.

FIG. 3 illustrates an example of a multi-scale convolutional neural network, according to an embodiment of the present disclosure.

FIG. 4 illustrates an example process for classifying content items, according to various embodiments of the present disclosure

FIG. 5 illustrates a network diagram of an example system including an example social networking system that can be utilized in various scenarios, according to an embodiment of the present disclosure.

FIG. 6 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Content Classification Using Convolutional Neural Networks

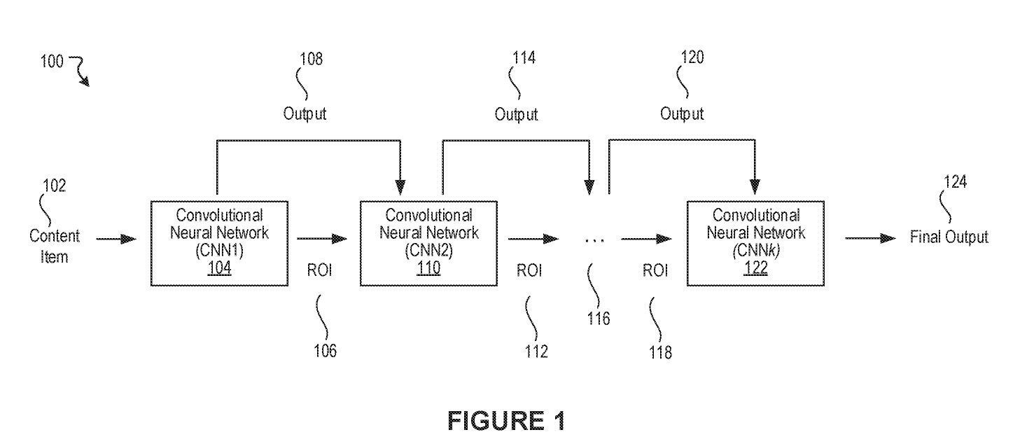

FIG. 1 illustrates an example of a cascaded convolutional neural network 100, according to an embodiment of the present disclosure. As shown, the cascaded CNN 100 can include any number of convolutional neural networks (CNN) 104, 110, 116, 122. Each CNN 104, 110, 116, 122 can include one or more convolutional layers, pooling layers, and fully-connected layers, for example. In various embodiments, content items submitted to the cascaded CNN 100 can be evaluated using a series of CNNs 104, 110, 116, 122 to determine a final output 124 for the submitted content item 102. The final output 124 may provide one or more indications (e.g., probabilities, binary values, etc.) regarding classifications of concepts in the submitted content item and, in some instances, may also provide the respective locations (e.g., a heat map, image coordinates, bounding boxes or regions, etc.) of those concepts that were identified in the content item.

The CNN 104 can be trained to evaluate a submitted content item to determine one or more regions of interest (ROI) in the content item that correspond to various concepts. Such concepts may include, for example, any number of scenes (e.g., outdoor scene, indoor scene, forest scene, living room scene, etc.), any number of items or objects (e.g., person, animal, bicycle, boat, etc.), and any number of movements or actions (e.g., jogging, jumping, walking, sitting, etc.), to name some examples. Further, each subsequent CNN 110, 116, 122 in the cascaded CNN 100 can be trained using labeled regions of interest that were identified by the preceding CNN. For example, the CNN 110 in the cascaded CNN 100 can be trained using labeled regions of interest that were determined using the preceding CNN 104. Similarly, the CNN subsequent to the CNN 110 can be trained using labeled regions of interest that were determined using the CNN 110.

The different CNNs 104, 110, 116, 122 included in the cascaded CNN 100 can be trained to optimize their classification capabilities with regard to particular concepts. When training a CNN, one or more annotated data sets may be utilized. The annotated data set can include various content items together with respective labels for concepts that are known to exist in those content items. For any given content item, the labels corresponding to concepts in the content item can also indicate a location, or region, in the content item to which that label corresponds. In some instances, any content items that are misclassified by a first CNN, as determined based at least in part on the respective labels corresponding those content items, can be used to train a subsequent, more specialized, CNN in a cascaded CNN. In various embodiments, the subsequent, more specialized, CNN may receive a zoomed-in portion(s) of the content item together with the corresponding label(s) to be used for training the subsequent CNN to classify content items more accurately.

In the example of FIG. 1, the CNN 104 can evaluate a submitted content item 102 to determine one or more regions of interest (ROI) in the content item 102. Next, regions of interest 106 identified by the first CNN 104 can be provided as input to the second CNN 110. As mentioned, the regions of interest can be provided as a heat map, image coordinates (e.g., pixel coordinates), bounding boxes or regions, etc. In some embodiments, the regions of interest can be provided as zoomed-in portions, or patches, of the content item 102. In some embodiments, the first CNN 104 can also provide the second CNN 110 with an output 108 that can include, for example, the content item 102 or portions of the content item 102, image classification data indicating a classification determination made by the first CNN 104, and/or feature descriptors corresponding to content item 102. A feature descriptor can be any semantic representation of concepts and/or features in a content item. In various embodiments, each subsequent CNN in the cascaded CNN 100 can be trained to more accurately classify one or more concepts than the preceding CNN. Thus, in the example of FIG. 1, the second CNN 110 has been trained to more accurately classify the regions of interest 106 than the first CNN 104 at which the regions of interest 106 were initially determined.

The CNN 110 is trained to identify different regions of interest 112 that correspond to various concepts. Such training may be done using labeled regions of interest that were identified by the CNN 104 and associated labels that identify a corresponding concept, for example. The regions of interest 112 identified by the CNN 110, as well as the output 114 (e.g., image classification data indicating a classification determination made by the CNN 110, feature descriptors corresponding to content item 102, and/or ROI 106) can be progressively provided to any number of subsequent CNNs 116, with the respective output and regions of interest determined by each CNN being provided as input to the next CNN in the cascaded CNN 100. The number of CNNs can be determined based at least in part on the structural configuration of the cascaded CNN 100 and/or the complexity of the content items to be classified. The last CNN 122 in the cascaded CNN 100 can be utilized to determine a final output 124 corresponding to the content item 102. As mentioned, the final output may provide one or more classifications and/or detections of concepts in the submitted content item 102 and, in some instances, may also provide the respective locations (e.g., a heat map, image coordinates, bounding boxes or regions, etc.) of those concepts that were identified in the content item. In various embodiments, the structural configuration of the cascaded CNN 100 can be automatically determined based at least in part on the one or more annotated data sets used to train the CNNs.

In some embodiments, the cascaded CNN 100 can be configured so that classifications and/or detections determined by a CNN can be confirmed by a subsequent CNN. For example, if the CNN 104 classified the content item 102 as including an image of a bird, then the respective classification determined by the subsequent CNN 110 can be utilized to determine whether the “bird” classification by the CNN 104 was a false positive or true positive, for example. Such information can be used, for example, to further refine the training of individual CNNs included in the cascaded CNN 100.

In various embodiments, the structural configuration of the cascaded CNN 100 can vary depending on the implementation and/or classification and/or detection objectives. For example, in some instances, the objective may be to provide a threshold level of classification accuracy without using excessive computing resources. In such instances, the structural configuration of the cascaded CNN 100 can include fewer intermediate CNNs to reduce the amount of time and/or processing complexity needed when classifying content items. In another example, in some instances, the objective may be to provide a high threshold level of classification accuracy. In such instances, the structural configuration of the cascaded CNN 100 can include additional intermediate CNNs which are trained to improve the classification accuracy. Such approaches can help optimize the use of computing resources based on the desired objectives.

The preceding examples describe modifying the structural configuration to achieve certain objectives (e.g., faster classification with a lower classification accuracy versus slower classification with a higher classification accuracy). However, in some embodiments, such objectives may be selectively achieved without such structural modifications. For example, the cascaded CNN 100 can be configured to process certain content items up to a threshold depth in the cascaded CNN 100 depending on any number of factors. In one example, the number of CNNs utilized for processing a content item can be determined based at least in part on the source (e.g., a particular source or user, a source or user's associated geographic region, a geographic location from where the content item was provided or uploaded, etc.) associated with the content item. For example, content items provided by popular entities (e.g., celebrities, public figures, well-known media outlets, etc.) may be more worthy of accurate classification and/or detection than content items provided by unpopular entities. In this example, the source that provided the content item, for example, to a social networking system, can be a factor that is used to determine the number of CNNs of the cascaded CNN 100 that are utilized for classifying and/or detecting the content item. In one example, a content item provided by an unpopular entity may be classified using two CNNs in a cascade while a content item provided by a popular entity may be classified using six CNNs in the cascade. Popularity of entities can be measured using various approaches including, for example, the number of social connections of the entity or simply the fact that the entity is a celebrity or public figure, to name some examples. Similarly, in some instances, the popularity of the content item being classified can be used to determine the number of CNNs to be utilized for classifying the content item. The popularity of a content item may be determined, for example, based on a measure of engagement with the content item including, for example, the number of endorsements or “likes” received for the content item, for example, by users of a social networking system.

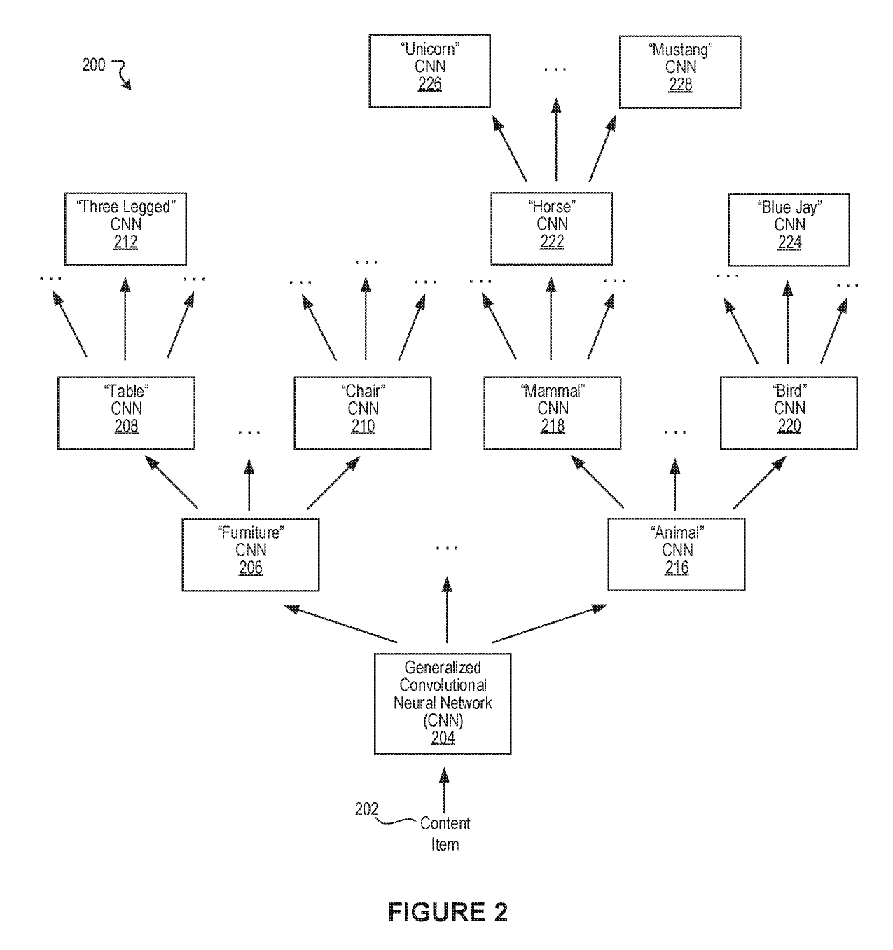

FIG. 2 illustrates another example of a cascaded convolutional neural network 200, according to an embodiment of the present disclosure. As shown, the cascaded CNN 200 can include a generalized convolutional neural network (CNN) 204 that can be configured to classify content items into one or more concepts. For example, for a content item that includes a representation of a dog, the generalized CNN 204 can determine respective probabilities for the concepts that were identified in the content item. To improve the classification accuracy of content items, in various embodiments, additional, more specialized, CNNs can be trained and utilized in a cascaded CNN architecture. In various embodiments, such specialized CNNs can be arranged, or cascaded, based on a taxonomy in which each subsequent CNN is trained to perform a more granular classification than its preceding CNN. In one example, as illustrated in FIG. 2, one taxonomy of CNNs can include a CNN 216 that is trained to classify animals, a CNN 218 that is trained to classify mammals, another CNN 222 that is trained to classify horses, and further CNNs 226, 228 trained to classify unicorns and mustangs, respectively. The taxonomy of CNNs illustrated in FIG. 2 is provided merely as an example and, naturally, there may be any number of layers, or depth, of CNNs arranged in a cascade and any number of specialized CNNs, as determined based at least in part on the taxonomy being utilized, the annotated training data set, and/or the level of complexity needed for content item classification.

In the example of FIG. 2, a content item 202 can be submitted to the generalized CNN 204 for classification. The generalized CNN 204 can determine respective probabilities for any concepts that were identified in the content item 202. In various embodiments, the concepts for which the generalized CNN 204 determines probabilities can be represented by leaf CNNs, or nodes, of the cascaded CNN 200. In FIG. 2, these leaf CNNs can include a CNN 212 trained to classify three-legged tables, a CNN 226 trained to classify unicorns, a CNN 228 trained to classify mustangs, and a CNN 224 trained to classify blue jays. In this example, the generalized CNN 204 can determine probabilities indicating an 82 percent probability that a three-legged table is represented in the content item 202, an 80 percent probability that a mustang horse is represented in the content item, and a 25 percent probability that a blue jay is represented in the content item. Here, the generalized CNN 204 is indicating that the content item includes a representation of a three-legged table with a confidence of 82 percent but also that the content item includes a representation of a mustang horse with a confidence of 80 percent and that the content item includes a representation of a blue jay with a confidence of 25 percent. In some instances, the highest probability may be used to classify the content item, which, in this example, would result in the content item 202 being classified as including a representation of a three-legged table. However, in other instances, a more accurate classification may be preferred.

In some embodiments, the cascaded CNN 200 can be configured to utilize specialized CN Ns to obtain a more accurate classification of the content item 202 based at least in part on the initial classification(s) determined by the generalized CNN 204. Referring to the example above, the cascaded CNN 200 can utilize specialized CNNs to obtain a more accurate probability as to whether the content item 202 includes a representation of a three-legged table, a mustang horse, and/or a blue jay. Depending on the implementation, a more accurate classification can be obtained for the concept having the highest probability, the concept having the lowest probability, a threshold number of concepts having the highest probabilities, the concepts having respective probabilities above a threshold probability, a threshold number of concepts having the lowest probabilities, the concepts having respective probabilities below a threshold probability, or any combination thereof. As mentioned, the probabilities used to make this determination can be determined by the generalized CNN 204.

In this example, the specialized CNNs of the cascaded CNN 200 are utilized to determine more accurate probabilities for the three-legged table and the mustang horse concepts determined by the generalized CNN 204. To obtain a more accurate probability as to whether the content item 202 indeed includes a representation of a three-legged table, the taxonomy branch corresponding to the CNN 212, which is trained to classify and/or detect three-legged tables, can be utilized. Thus, in the example of FIG. 2, the output of the generalized CNN 204 can be provided into the top-level layer in the taxonomy branch corresponding to (e.g., containing) the three-legged table CNN 212 which, in this example, is the furniture CNN 206.

The output provided to a subsequent CNN can include the content item 202, a zoomed-in portion of the content item 202 (e.g., a zoomed-in portion of the content item 202 that corresponds to the region identified as corresponding to the three-legged table), classification data indicating a classification determination made by the CNN, feature descriptor(s), and/or the respective location (e.g., heat map, coordinates, bounding boxes or regions, etc.) in the content item 202 that corresponds to the three-legged table.

The furniture CNN 206 can evaluate the output from the generalized CNN 204 to determine probabilities for any concepts or concepts relating to furniture, depending on the implementation. In this example, the furniture CNN 206 may determine with a 86 percent probability that the content item 202 includes a representation of a table. In this example, to continue obtaining a better accuracy, the output from the furniture CNN 206 can be provided to the table CNN 208 that is trained to classify and/or detect tables. The table CNN 208 may determine with an 88 percent probability that the content item 202 includes a representation of a three-legged table. To continue obtaining a better accuracy, the output from the table CNN 208 can be provided to the three-legged table CNN 212 that is trained to classify and/or detect three-legged tables. In this example, the three-legged table CNN 212 may determine with a 96 percent probability that the content item 202 includes a representation of a three-legged table. Thus, by cascading through the taxonomy of specialized CNNs 206, 208, 212, the probability of there being a representation of a three-legged table in the content item 202 has gone from 82 percent, as determined by the generalized CNN 204, to 96 percent, as determined by the specialized three-legged table CNN 212.

Similarly, to obtain a more accurate probability as to whether the content item 202 includes a representation of a mustang horse, the taxonomy branch corresponding to the CNN 228, which is trained to classify and/or detect mustang horses, can be utilized. Thus, in the example of FIG. 2, the output of the generalized CNN 204 can be provided into the top-level layer in the taxonomy branch corresponding to (e.g., containing) the mustang horse CNN 228 which, in this example, is the animal CNN 216. The animal CNN 216 can evaluate the output from the generalized CNN 204 to determine probabilities for any concepts or concepts relating to animals, depending on the implementation. In this example, the animal CNN 216 may determine with a 75 percent probability that the content item 202 includes a representation of a mammal. In this example, to continue obtaining a better accuracy, the output from the animal CNN 216 can be provided to the mammal CNN 218 that is trained to classify and/or detect mammals.

The mammal CNN 218 can evaluate the output from the animal CNN 216 to determine probabilities for any concepts identified by the animal CNN 216. In this example, the mammal CNN 218 may determine with a 70 percent probability that the content item 202 includes a representation of a horse. In this example, to continue obtaining a better accuracy, the output from the mammal CNN 218 can be provided to the horse CNN 222 that is trained to classify and/or detect horses. The horse CNN 222 may determine with a 60 percent probability that the content item 202 includes a representation of a mustang horse. To obtain more accuracy, the output of the horse CNN 222 may be inputted to the mustang CNN 228, which may determine a probability of 15 percent that the content item 202 includes a representation of a mustang horse. Thus, by cascading through the taxonomy of specialized CNNs 216, 218, 222, 228, the probability of there being a representation of a mustang horse in the content item 202 has gone from 80 percent, as determined by the generalized CNN 204, to 15 percent, as determined by the specialized mustang horse CNN 228. By utilizing cascading CNNs to classify content items, the cascaded CNNs are able to learn from the preceding CNNs in their respective taxonomic branches. Thus, in this example, the content item 202, which initially had an 82 percent likelihood of including a representation of a three-legged table and an 80 percent likelihood of including a mustang horse, can more accurately be classified and/or detected to include the representation of the three-legged table with a probability of 96 percent, as determined by the three-legged CNN 212, and not a representation of a mustang horse which was determined to have a probability of 15 percent, as determined by the mustang horse CNN 228.

In many instances, the accuracy of a concept that is represented in a content item can continue to increase as the more specialized CNNs are utilized. For example, as described above, the initial probability of the content item 202 including a representation of a three-legged table went from 82 percent, as determined by the generalized CNN 204, to 96 percent, as determined by the specialized three-legged table CNN 212. Similarly, the accuracy of a concept that is not represented in a content item can continue to increase as the more specialized CNNs are utilized. For example, as described above, the initial probability of the content item 202 including a representation of a mustang horse went from 80 percent, as determined by the generalized CNN 204, to 15 percent, as determined by the specialized mustang horse CNN 228. In various embodiments, the cascaded CNN 200 can be configured to cease processing a content item with respect to a certain concept once a threshold probability has been achieved. For example, the processing of the content item 202 may have ceased once the table CNN 208 determined with an 88 percent probability that the content item 202 included a representation of a three-legged table. Similarly, the processing of the content item 202 may have ceased with respect to the mustang horse once the horse CNN 222 determined with a 60 percent probability that the content item 202 includes a representation of a mustang horse.

Other approaches may be applied for increasing or limiting the depth, or the number of specialized CNNs utilized, for classifying and/or detecting a given content item. For example, in some embodiments, the source (e.g., a particular source or user, the source or user's associated geographic region, a geographic location from where the content item was provided or uploaded, etc.) associated with the content item can be used to determine the number of specialized CNNs utilized for classification and/or detection of the content item, as described above. Further, an interface, or page, to which the content item was provided, or posted, may also be a factor in determining whether to use certain CNNs, a certain taxonomy of CNNs, and/or more or fewer CNNs. For example, a content item uploaded to a page for wildlife preservation can be automatically processed using the taxonomy of specialized CNNs cascaded under the animal CNN 216. This processing can be automated, for example, based on any tags or categorizations associated with the interface or page (or content of the interface or page) through which the content item is provided.

In some embodiments, the generalized CNN 204 can initially be utilized for classifying and/or detecting content items. If the generalized CNN 204 determines that one or more concepts are represented in a content item with a threshold accuracy, then the specialized CNNs are not utilized. In some embodiments, the generalized CNN 204 can be utilized for classification and/or detection on a mobile computing device and the functionality of the specialized CNNs can be provided by a remote server or cloud-based computing system. For example, the specialized CNNs can be utilized if the initial probabilities determined by the generalized CNN 204 on the mobile computing device do not satisfy one or more thresholds and/or concept-specific thresholds. Using this approach, content items can be classified with a threshold level of accuracy on a mobile computing device while reserving bandwidth usage for more complex classification and/or detection problems.

In various embodiments, once the generalized CNN 204 determines probabilities for one or more concepts, the subsequent specialized CNNs can be utilized based at least in part on their capacity to provide a more accurate probability for those concepts.

In various embodiments, this taxonomy of CNNs, as described in reference to FIG. 2, can be determined automatically, for example, based at least in part on the level of complexity needed for content item classification/detection and/or by evaluating annotated data sets that can be used to train the cascaded CNN 200. In various embodiments, the taxonomy can be automatically determined using a data driven approach that can indicate the data, or taxonomic, segmentations that provide more accurate classifications and/or detections. The data driven approach may use any number of clustering techniques, for example, to make such determinations. For example, a CNN may be trained to distinguish between a dog and a cat, but may have issues distinguishing between a white dog and white cat and/or a black dog and black cat. In this example, a data driven approach may determine that a better segmentation would be to train a model to differentiate between white and black colors and then a subsequent, cascaded, CNN for differentiating between dogs and cats.

In some embodiments, the specialized CNNs in any given taxonomy can be trained using annotated training content items, or portions of the annotated content items, based on classification and/or detection mistakes made by the preceding CNN. In various embodiments, when evaluating a content item that includes a representation of a particular concept, a classification and/or detection mistake can be determined when a CNN does not determine that the concept is represented in a content item with a threshold level of accuracy. Similarly, when evaluating a content item that does not include a representation of a particular concept, a classification and/or detection mistake can be determined when a CNN determines that the concept is represented in the content item with a threshold level of accuracy. For example, a content item may include representations of a bicycle and a blue jay. In this example, the generalized CNN 204 may determine with a threshold accuracy that a bicycle is represented in the content item, but not the blue jay. In this example, the labeled portion of the content item corresponding to the representation of the blue jay can be used to train a cascaded CNN (e.g., the animal CNN 216).

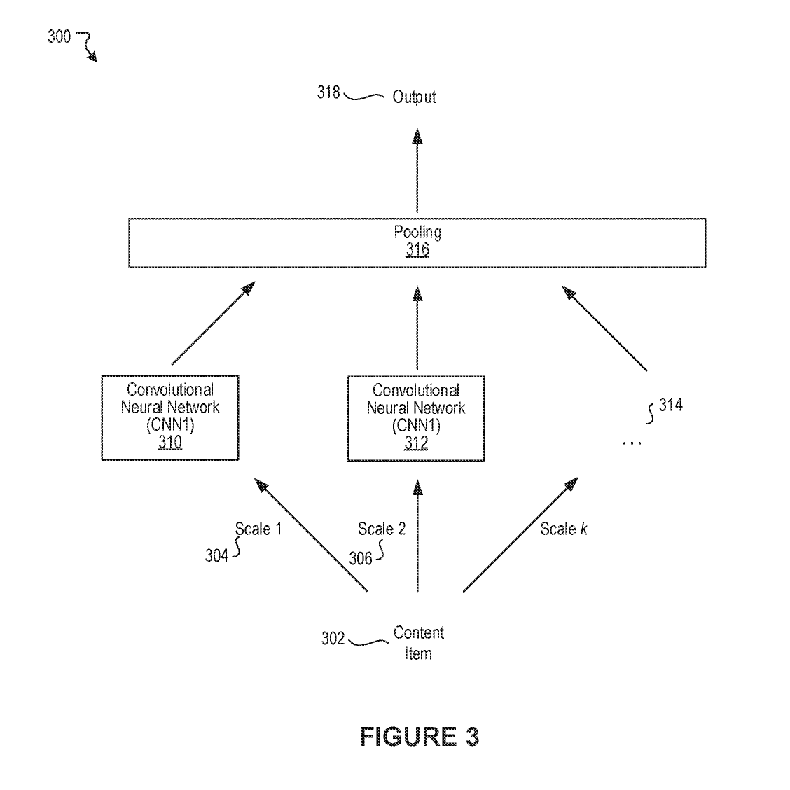

FIG. 3 illustrates an example of a multi-scale convolutional neural network (CNN) 300, according to an embodiment of the present disclosure. In various embodiments, the cascaded CNNs, as described in reference to FIGS. 1 and 2 can be configured to support multi-scale input. The CNNs 310, 312, 314 can each refer to individual CNNs or, depending on the implementation, multiple CNNs in a corresponding cascade, for example, similar to the cascade configurations described in reference to FIGS. 1 and 2, however, such structures are not illustrated in FIG. 3 for simplicity. That is, content items can be inputted to the various CNNs (such as, e.g., the first or the generalized CNN) of the cascaded CNNs at their original scale and also at a number of different scales (e.g., 200×200 pixels, 500×500 pixels, 1000×1000 pixels, etc.) to help improve classification and/or detection accuracies.

However, in some embodiments, the multi-scale CNN 300 can be configured to include any number of CNNs 310, 312, 314 (or cascaded CNNs 310, 312, 314) that are each trained to classify and/or detect content items at a specific scale. For example, the CNN 310 (or cascaded CNN 310) can be trained to process a content item 302 at a first scale 304 (e.g., 500×500 pixels) and the CNN 312 (or cascaded CNN 312) can be trained to process the content item 302 at a second scale 306 (e.g., 1000×1000 pixels). In various embodiments, each of the CNNs 310, 312, 314 (or cascaded CNNs 310, 312, 314) of the multi-scale CNN 300 can be trained in an identical, or similar, manner. Naturally, the number of CNNs 310, 312, 314 (or cascaded CNNs 310, 312, 314) included in the multi-scale CNN 300 can vary depending on the number of different scales at which content items are to be evaluated. The output from each of the different CNNs 310, 312, 314 (or cascaded CNNs 310, 312, 314) can be submitted to a pooling layer 316. The pooling layer 316 receives the probability predictions from each of the CNNs 310, 312, 314 (or cascaded CNNs 310, 312, 314) at varying scale sizes. Each CNN 310, 312, 314 (or cascaded CNN 310, 312, 314) can provide a set of patches that are determined based on the scale of the content item processed by the respective CNN 310, 312, 314 (or cascaded CNN 310, 312, 314). The pooling layer 316 can evaluate the different patches for each scale using a max pooling approach, an average pooling approach, or a LogSumExp (LSE) approach, which has temperature as a parameter. The pooling layer 316 can utilize heat maps to detect the respective locations of the concepts identified in the evaluated content items. Further, the pooling layer 316 can provide, as output 318, classifications and/or detections for one or more concepts identified in the content item 302 as well as the respective locations in the content item in which the concepts were identified.

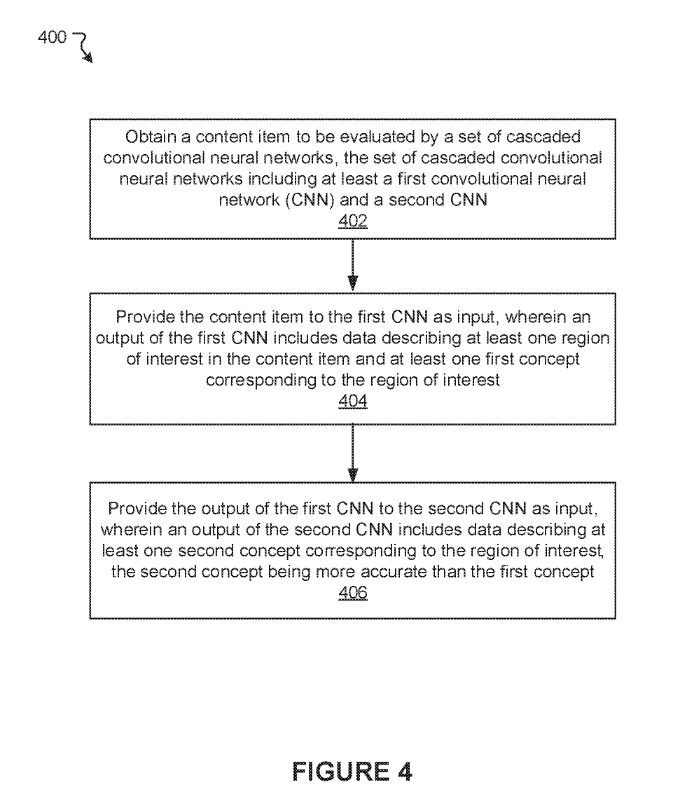

FIG. 4 illustrates an example process 400 for classifying content items, according to various embodiments of the present disclosure. It should be appreciated that there can be additional, fewer, or alternative steps performed in similar or alternative orders, or in parallel, within the scope of the various embodiments discussed herein unless otherwise stated. At block 402, a content item to be evaluated by a set of cascaded convolutional neural networks can be obtained. The set of cascaded convolutional neural networks can include at least a first convolutional neural network (CNN) and a second CNN. At block 404, the content item can be provided to the first CNN as input, the first CNN including at least one convolutional layer, pooling layer, and fully-connected layer, wherein an output of the first CNN includes data describing at least one region of interest in the content item and at least one first concept corresponding to the region of interest. At block 406, the output of the first CNN can be provided to the second CNN as input, the second CNN including at least one convolutional layer, pooling layer, and fully-connected layer, wherein an output of the second CNN includes data describing at least one second concept corresponding to the region of interest, the second concept being more accurate than the first concept.

It is contemplated that there can be many other uses, applications, and/or variations associated with the various instances of the present disclosure. For example, in some cases, user can choose whether or not to opt-in to utilize the disclosed technology. The disclosed technology can also ensure that various privacy settings and preferences are maintained and can prevent private information from being divulged. In another example, various instances of the present disclosure can learn, improve, and/or be refined over time.

### Social Networking System-Example Implementation

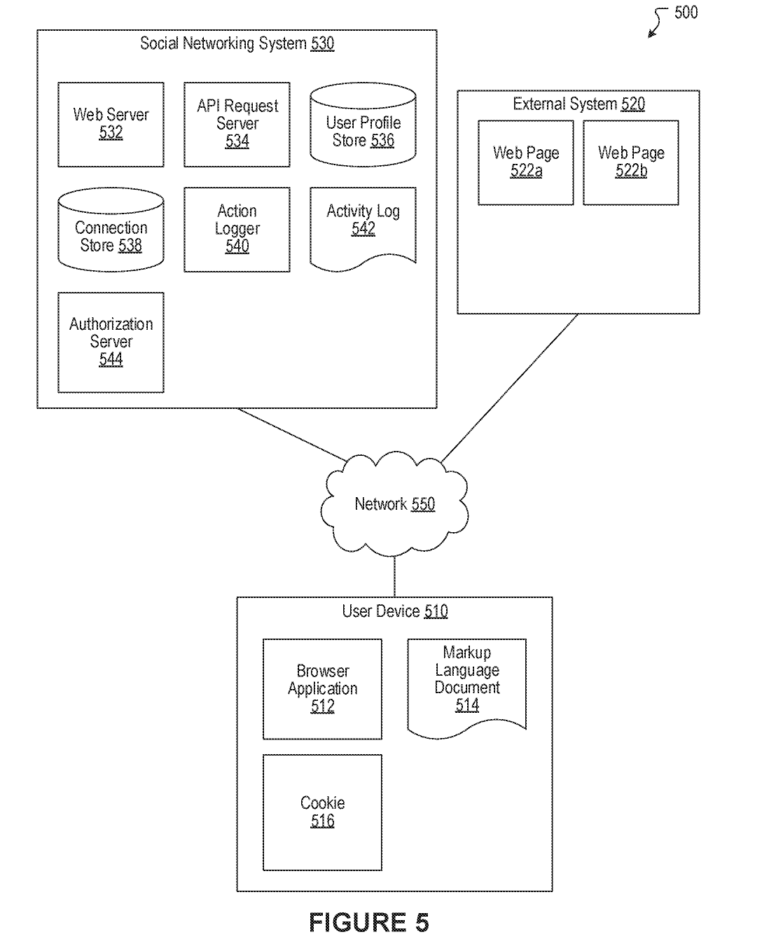

FIG. 5 illustrates a network diagram of an example system 500 that can be utilized in various scenarios, in accordance with an embodiment of the present disclosure. The system 500 includes one or more user devices 510, one or more external systems 520, a social networking system (or service) 530, and a network 550. In an embodiment, the social networking service, provider, and/or system discussed in connection with the embodiments described above may be implemented as the social networking system 530. For purposes of illustration, the embodiment of the system 500, shown by FIG. 5, includes a single external system 520 and a single user device 510. However, in other embodiments, the system 500 may include more user devices 510 and/or more external systems 520. In certain embodiments, the social networking system 530 is operated by a social network provider, whereas the external systems 520 are separate from the social networking system 530 in that they may be operated by different entities. In various embodiments, however, the social networking system 530 and the external systems 520 operate in conjunction to provide social networking services to users (or members) of the social networking system 530. In this sense, the social networking system 530 provides a platform or backbone, which other systems, such as external systems 520, may use to provide social networking services and functionalities to users across the Internet.

The user device 510 comprises one or more computing devices (or systems) that can receive input from a user and transmit and receive data via the network 550. In one embodiment, the user device 510 is a conventional computer system executing, for example, a Microsoft Windows compatible operating system (OS), Apple OS X, and/or a Linux distribution. In another embodiment, the user device 510 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 510 is configured to communicate via the network 550. The user device 510 can execute an application, for example, a browser application that allows a user of the user device 510 to interact with the social networking system 530. In another embodiment, the user device 510 interacts with the social networking system 530 through an application programming interface (API) provided by the native operating system of the user device 510, such as iOS and ANDROID. The user device 510 is configured to communicate with the external system 520 and the social networking system 530 via the network 550, which may comprise any combination of local area and/or wide area networks, using wired and/or wireless communication systems.

In one embodiment, the network 550 uses standard communications technologies and protocols. Thus, the network 550 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 550 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 550 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 510 may display content from the external system 520 and/or from the social networking system 530 by processing a markup language document 514 received from the external system 520 and from the social networking system 530 using a browser application 512. The markup language document 514 identifies content and one or more instructions describing formatting or presentation of the content. By executing the instructions included in the markup language document 514, the browser application 512 displays the identified content using the format or presentation described by the markup language document 514. For example, the markup language document 514 includes instructions for generating and displaying a web page having multiple frames that include text and/or image data retrieved from the external system 520 and the social networking system 530. In various embodiments, the markup language document 514 comprises a data file including extensible markup language (XML) data, extensible hypertext markup language (XHTML) data, or other markup language data. Additionally, the markup language document 514 may include JavaScript Object Notation (JSON) data, JSON with padding (JSONP), and JavaScript data to facilitate data-interchange between the external system 520 and the user device 510. The browser application 512 on the user device 510 may use a JavaScript compiler to decode the markup language document 514.

The markup language document 514 may also include, or link to, applications or application frameworks such as FLASH™ or Unity™ applications, the Silverlight™ application framework, etc.

In one embodiment, the user device 510 also includes one or more cookies 516 including data indicating whether a user of the user device 510 is logged into the social networking system 530, which may enable modification of the data communicated from the social networking system 530 to the user device 510.

The external system 520 includes one or more web servers that include one or more web pages 522a, 522b, which are communicated to the user device 510 using the network 550. The external system 520 is separate from the social networking system 530. For example, the external system 520 is associated with a first domain, while the social networking system 530 is associated with a separate social networking domain. Web pages 522a, 522b, included in the external system 520, comprise markup language documents 514 identifying content and including instructions specifying formatting or presentation of the identified content. As discussed previously, it should be appreciated that there can be many variations or other possibilities.

The social networking system 530 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 530 may be administered, managed, or controlled by an operator. The operator of the social networking system 530 may be a human being, an automated application, or a series of applications for managing content, regulating policies, and collecting usage metrics within the social networking system 530. Any type of operator may be used.

Users may join the social networking system 530 and then add connections to any number of other users of the social networking system 530 to whom they desire to be connected. As used herein, the term “friend” refers to any other user of the social networking system 530 to whom a user has formed a connection, association, or relationship via the social networking system 530. For example, in an embodiment, if users in the social networking system 530 are represented as nodes in the social graph, the term “friend” can refer to an edge formed between and directly connecting two user nodes.

Connections may be added explicitly by a user or may be automatically created by the social networking system 530 based on common characteristics of the users (e.g., users who are alumni of the same educational institution). For example, a first user specifically selects a particular other user to be a friend. Connections in the social networking system 530 are usually in both directions, but need not be, so the terms “user” and “friend” depend on the frame of reference. Connections between users of the social networking system 530 are usually bilateral (“two-way”), or “mutual,” but connections may also be unilateral, or “one-way.” For example, if Bob and Joe are both users of the social networking system 530 and connected to each other, Bob and Joe are each other's connections. If, on the other hand, Bob wishes to connect to Joe to view data communicated to the social networking system 530 by Joe, but Joe does not wish to form a mutual connection, a unilateral connection may be established. The connection between users may be a direct connection; however, some embodiments of the social networking system 530 allow the connection to be indirect via one or more levels of connections or degrees of separation.

In addition to establishing and maintaining connections between users and allowing interactions between users, the social networking system 530 provides users with the ability to take actions on various types of items supported by the social networking system 530. These items may include groups or networks (i.e., social networks of people, entities, and concepts) to which users of the social networking system 530 may belong, events or calendar entries in which a user might be interested, computer-based applications that a user may use via the social networking system 530, transactions that allow users to buy or sell items via services provided by or through the social networking system 530, and interactions with advertisements that a user may perform on or off the social networking system 530. These are just a few examples of the items upon which a user may act on the social networking system 530, and many others are possible. A user may interact with anything that is capable of being represented in the social networking system 530 or in the external system 520, separate from the social networking system 530, or coupled to the social networking system 530 via the network 550.

The social networking system 530 is also capable of linking a variety of entities. For example, the social networking system 530 enables users to interact with each other as well as external systems 520 or other entities through an API, a web service, or other communication channels. The social networking system 530 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 530. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 530 modifies edges connecting the various nodes to reflect the relationships and interactions.

The social networking system 530 also includes user-generated content, which enhances a user's interactions with the social networking system 530. User-generated content may include anything a user can add, upload, send, or “post” to the social networking system 530. For example, a user communicates posts to the social networking system 530 from a user device 510. Posts may include data such as status updates or other textual data, location information, images such as photos, videos, links, music or other similar data and/or media. Content may also be added to the social networking system 530 by a third party. Content “items” are represented as objects in the social networking system 530. In this way, users of the social networking system 530 are encouraged to communicate with each other by posting text and content items of various types of media through various communication channels. Such communication increases the interaction of users with each other and increases the frequency with which users interact with the social networking system 530.

The social networking system 530 includes a web server 532, an API request server 534, a user profile store 536, a connection store 538, an action logger 540, an activity log 542, and an authorization server 544. In an embodiment of the invention, the social networking system 530 may include additional, fewer, or different components for various applications. Other components, such as network interfaces, security mechanisms, load balancers, failover servers, management and network operations consoles, and the like are not shown so as to not obscure the details of the system.

The user profile store 536 maintains information about user accounts, including biographic, demographic, and other types of descriptive information, such as work experience, educational history, hobbies or preferences, location, and the like that has been declared by users or inferred by the social networking system 530. This information is stored in the user profile store 536 such that each user is uniquely identified. The social networking system 530 also stores data describing one or more connections between different users in the connection store 538. The connection information may indicate users who have similar or common work experience, group memberships, hobbies, or educational history. Additionally, the social networking system 530 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 530, such as non-person entities, buckets, cluster centers, images, interests, pages, external systems, concepts, and the like are also stored in the connection store 538.

The social networking system 530 maintains data about objects with which a user may interact. To maintain this data, the user profile store 536 and the connection store 538 store instances of the corresponding type of objects maintained by the social networking system 530. Each object type has information fields that are suitable for storing information appropriate to the type of object. For example, the user profile store 536 contains data structures with fields suitable for describing a user's account and information related to a user's account. When a new object of a particular type is created, the social networking system 530 initializes a new data structure of the corresponding type, assigns a unique object identifier to it, and begins to add data to the object as needed. This might occur, for example, when a user becomes a user of the social networking system 530, the social networking system 530 generates a new instance of a user profile in the user profile store 536, assigns a unique identifier to the user account, and begins to populate the fields of the user account with information provided by the user.

The connection store 538 includes data structures suitable for describing a user's connections to other users, connections to external systems 520 or connections to other entities. The connection store 538 may also associate a connection type with a user's connections, which may be used in conjunction with the user's privacy setting to regulate access to information about the user. In an embodiment of the invention, the user profile store 536 and the connection store 538 may be implemented as a federated database.

Data stored in the connection store 538, the user profile store 536, and the activity log 542 enables the social networking system 530 to generate the social graph that uses nodes to identify various objects and edges connecting nodes to identify relationships between different objects. For example, if a first user establishes a connection with a second user in the social networking system 530, user accounts of the first user and the second user from the user profile store 536 may act as nodes in the social graph. The connection between the first user and the second user stored by the connection store 538 is an edge between the nodes associated with the first user and the second user. Continuing this example, the second user may then send the first user a message within the social networking system 530. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 530 (or, alternatively, in an image maintained by another system outside of the social networking system 530). The image may itself be represented as a node in the social networking system 530. This tagging action may create edges between the first user and the second user as well as create an edge between each of the users and the image, which is also a node in the social graph. In yet another example, if a user confirms attending an event, the user and the event are nodes obtained from the user profile store 536, where the attendance of the event is an edge between the nodes that may be retrieved from the activity log 542. By generating and maintaining the social graph, the social networking system 530 includes data describing many different types of objects and the interactions and connections among those objects, providing a rich source of socially relevant information.

The web server 532 links the social networking system 530 to one or more user devices 510 and/or one or more external systems 520 via the network 550. The web server 532 serves web pages, as well as other web-related content, such as Java, JavaScript, Flash, XML, and so forth. The web server 532 may include a mail server or other messaging functionality for receiving and routing messages between the social networking system 530 and one or more user devices 510. The messages can be instant messages, queued messages (e.g., email), text and SMS messages, or any other suitable messaging format.

The API request server 534 allows one or more external systems 520 and user devices 510 to call access information from the social networking system 530 by calling one or more API functions. The API request server 534 may also allow external systems 520 to send information to the social networking system 530 by calling APIs. The external system 520, in one embodiment, sends an API request to the social networking system 530 via the network 550, and the API request server 534 receives the API request. The API request server 534 processes the request by calling an API associated with the API request to generate an appropriate response, which the API request server 534 communicates to the external system 520 via the network 550. For example, responsive to an API request, the API request server 534 collects data associated with a user, such as the user's connections that have logged into the external system 520, and communicates the collected data to the external system 520. In another embodiment, the user device 510 communicates with the social networking system 530 via APIs in the same manner as external systems 520.

The action logger 540 is capable of receiving communications from the web server 532 about user actions on and/or off the social networking system 530. The action logger 540 populates the activity log 542 with information about user actions, enabling the social networking system 530 to discover various actions taken by its users within the social networking system 530 and outside of the social networking system 530. Any action that a particular user takes with respect to another node on the social networking system 530 may be associated with each user's account, through information maintained in the activity log 542 or in a similar database or other data repository. Examples of actions taken by a user within the social networking system 530 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 530, the action is recorded in the activity log 542. In one embodiment, the social networking system 530 maintains the activity log 542 as a database of entries. When an action is taken within the social networking system 530, an entry for the action is added to the activity log 542. The activity log 542 may be referred to as an action log.

Additionally, user actions may be associated with concepts and actions that occur within an entity outside of the social networking system 530, such as an external system 520 that is separate from the social networking system 530. For example, the action logger 540 may receive data describing a user's interaction with an external system 520 from the web server 532. In this example, the external system 520 reports a user's interaction according to structured actions and objects in the social graph.

Other examples of actions where a user interacts with an external system 520 include a user expressing an interest in an external system 520 or another entity, a user posting a comment to the social networking system 530 that discusses an external system 520 or a web page 522a within the external system 520, a user posting to the social networking system 530 a Uniform Resource Locator (URL) or other identifier associated with an external system 520, a user attending an event associated with an external system 520, or any other action by a user that is related to an external system 520. Thus, the activity log 542 may include actions describing interactions between a user of the social networking system 530 and an external system 520 that is separate from the social networking system 530.

The authorization server 544 enforces one or more privacy settings of the users of the social networking system 530. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 520, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 520. One embodiment allows the specification of the set of entities to comprise an enumeration of entities. For example, the user may provide a list of external systems 520 that are allowed to access certain information. Another embodiment allows the specification to comprise a set of entities along with exceptions that are not allowed to access the information. For example, a user may allow all external systems 520 to access the user's work information, but specify a list of external systems 520 that are not allowed to access the work information. Certain embodiments call the list of exceptions that are not allowed to access certain information a “block list”. External systems 520 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 544 contains logic to determine if certain information associated with a user can be accessed by a user's friends, external systems 520, and/or other applications and entities. The external system 520 may need authorization from the authorization server 544 to access the user's more private and sensitive information, such as the user's work phone number. Based on the user's privacy settings, the authorization server 544 determines if another user, the external system 520, an application, or another entity is allowed to access information associated with the user, including information about actions taken by the user.

In some embodiments, the social networking system 530 can include one or more modules for performing the various operations described above in reference to FIGS. 1-4.

### Hardware Implementation

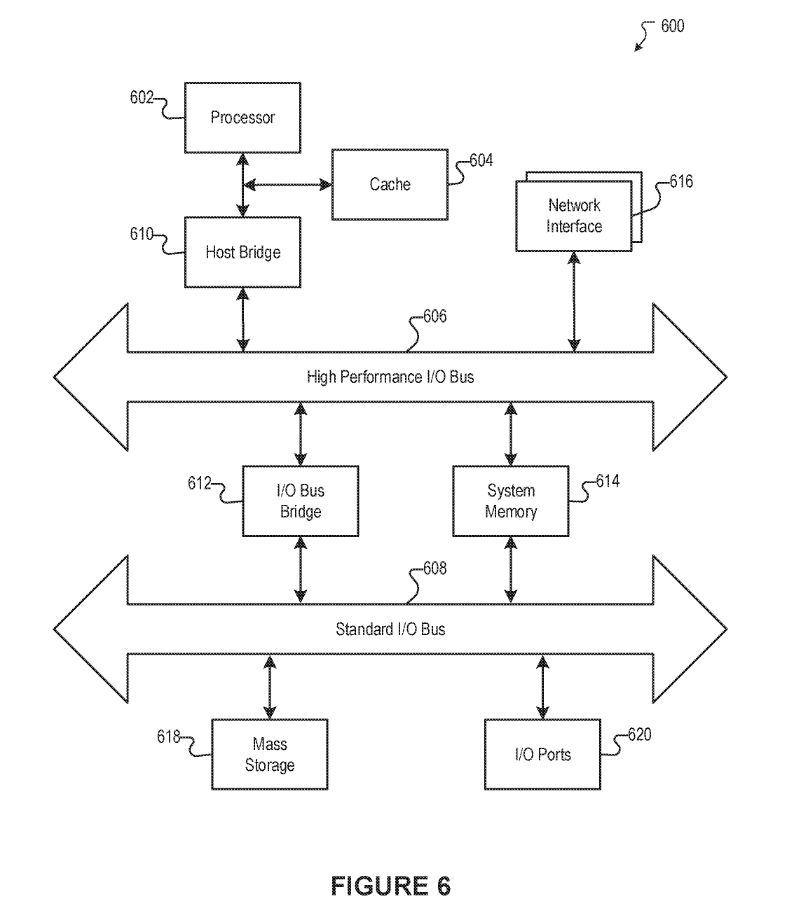

The foregoing processes and features can be implemented by a wide variety of machine and computer system architectures and in a wide variety of network and computing environments. FIG. 6 illustrates an example of a computer system 600 that may be used to implement one or more of the embodiments described herein in accordance with an embodiment of the invention. The computer system 600 includes sets of instructions for causing the computer system 600 to perform the processes and features discussed herein. The computer system 600 may be connected (e.g., networked) to other machines. In a networked deployment, the computer system 600 may operate in the capacity of a server machine or a client machine in a client-server network environment, or as a peer machine in a peer-to-peer (or distributed) network environment. In an embodiment of the invention, the computer system 600 may be the social networking system 530, the user device 510, and the external system 620, or a component thereof. In an embodiment of the invention, the computer system 600 may be one server among many that constitutes all or part of the social networking system 530.

The computer system 600 includes a processor 602, a cache 604, and one or more executable modules and drivers, stored on a computer-readable medium, directed to the processes and features described herein. Additionally, the computer system 600 includes a high performance input/output (I/O) bus 606 and a standard I/O bus 608. A host bridge 610 couples processor 602 to high performance I/O bus 606, whereas I/O bus bridge 612 couples the two buses 606 and 608 to each other. A system memory 614 and one or more network interfaces 616 couple to high performance I/O bus 606. The computer system 600 may further include video memory and a display device coupled to the video memory (not shown). Mass storage 618 and I/O ports 620 couple to the standard I/O bus 608. The computer system 600 may optionally include a keyboard and pointing device, a display device, or other input/output devices (not shown) coupled to the standard I/O bus 608. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 600, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 600 are described in greater detail below. In particular, the network interface 616 provides communication between the computer system 600 and any of a wide range of networks, such as an Ethernet (e.g., IEEE 802.3) network, a backplane, etc. The mass storage 618 provides permanent storage for the data and programming instructions to perform the above-described processes and features implemented by the respective computing systems identified above, whereas the system memory 614 (e.g., DRAM) provides temporary storage for the data and programming instructions when executed by the processor 602. The I/O ports 620 may be one or more serial and/or parallel communication ports that provide communication between additional peripheral devices, which may be coupled to the computer system 600.

The computer system 600 may include a variety of system architectures, and various components of the computer system 600 may be rearranged. For example, the cache 604 may be on-chip with processor 602. Alternatively, the cache 604 and the processor 602 may be packed together as a “processor module”, with processor 602 being referred to as the “processor core”. Furthermore, certain embodiments of the invention may neither require nor include all of the above components. For example, peripheral devices coupled to the standard I/O bus 608 may couple to the high performance I/O bus 606. In addition, in some embodiments, only a single bus may exist, with the components of the computer system 600 being coupled to the single bus. Moreover, the computer system 600 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 600 that, when read and executed by one or more processors, cause the computer system 600 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 600, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 602. Initially, the series of instructions may be stored on a storage device, such as the mass storage 618. However, the series of instructions can be stored on any suitable computer readable storage medium. Furthermore, the series of instructions need not be stored locally, and could be received from a remote storage device, such as a server on a network, via the network interface 616. The instructions are copied from the storage device, such as the mass storage 618, into the system memory 614 and then accessed and executed by the processor 602. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 600 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to one embodiment“, an embodiment”, “other embodiments”, one series of embodiments“, some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

What is claimed is:

1. A computer-implemented method comprising:
obtaining, by a computing system, a content item to be evaluated by a set of cascaded convolutional neural networks, the set of cascaded convolutional neural networks including at least a first convolutional neural network (CNN) and a second CNN;
providing, by the computing system, the content item to the first CNN as input, the first CNN including at least one convolutional layer, pooling layer, and fully-connected layer, wherein an output of the first CNN includes data describing at least one region of interest in the content item and at least one first concept corresponding to the region of interest; and
providing, by the computing system, the output of the first CNN to the second CNN as input, the second CNN including at least one convolutional layer, pooling layer, and fully-connected layer, wherein an output of the second CNN includes data describing at least one second concept corresponding to the region of interest, the second concept being more accurate than the first concept.

2. The computer-implemented method of claim 1, the method further comprising:
causing, by the computing system, the first CNN to be trained using at least a set of annotated training examples, wherein a training example includes a content item and at least one label for the content item that identifies (i) a concept captured in the content item and (ii) a location corresponding to the concept in the content item.

3. The computer-implemented method of claim 2, the method further comprising:
causing, by the computing system, the second CNN to be trained using at least some outputs that were produced by the first CNN.

4. The computer-implemented method of claim 1, wherein providing the output of the first CNN to the second CNN as input further comprises:
providing, by the computing system, a zoomed-in portion of the at least one region of interest to the second CNN.

5. The computer-implemented method of claim 1, wherein the output of the second CNN includes data describing at least one second region of interest in the content item and at least one concept corresponding to the second region of interest.

6. The computer-implemented method of claim 1, the method further comprising:
providing, by the computing system, the output of the second CNN to a third CNN as input, the third CNN including at least one convolutional layer, pooling layer, and fully-connected layer, wherein an output of the third CNN includes information describing at least one third concept corresponding to the region of interest, the third concept being more accurate than the second concept.

7. The computer-implemented method of claim 6, wherein providing the output of the second CNN to the third CNN further comprises:
before providing the output of the second CNN to the third CNN, determining, by the computing system, that a user of a social networking system that is associated with the content item satisfies one or more criteria.

8. The computer-implemented method of claim 1, wherein the output of the second CNN further includes location information corresponding to the second concept.

9. The computer-implemented method of claim 8, wherein the location information includes at least one of a heat map, pixel coordinates, or bounding region.

10. The computer-implemented method of claim 1, wherein the at least one second concept corresponds to a scene, item, object, motion, or action represented in the content item.

11. A system comprising:
at least one processor; and
a memory storing instructions that, when executed by the at least one processor, cause the system to perform:
obtaining a content item to be evaluated by a set of cascaded convolutional neural networks, the set of cascaded convolutional neural networks including at least a first convolutional neural network (CNN) and a second CNN;
providing the content item to the first CNN as input, the first CNN including at least one convolutional layer, pooling layer, and fully-connected layer, wherein an output of the first CNN includes data describing at least one region of interest in the content item and at least one first concept corresponding to the region of interest; and
providing the output of the first CNN to the second CNN as input, the second CNN including at least one convolutional layer, pooling layer, and fully-connected layer, wherein an output of the second CNN includes data describing at least one second concept corresponding to the region of interest, the second concept being more accurate than the first concept.

12. The system of claim 11, wherein the system further performs:
causing the first CNN to be trained using at least a set of annotated training examples, wherein a training example includes a content item and at least one label for the content item that identifies (i) a concept captured in the content item and (ii) a location corresponding to the concept in the content item.

13. The system of claim 12, wherein the system further performs:
causing the second CNN to be trained using at least some outputs that were produced by the first CNN.

14. The system of claim 11, wherein providing the output of the first CNN to the second CNN as input further causes the system to perform:
providing a zoomed-in portion of the at least one region of interest to the second CNN.

15. The system of claim 11, wherein the output of the second CNN includes data describing at least one second region of interest in the content item and at least one concept corresponding to the second region of interest.

16. A non-transitory computer-readable storage medium including instructions that, when executed by at least one processor of a computing system, cause the computing system to perform a method comprising:
obtaining a content item to be evaluated by a set of cascaded convolutional neural networks, the set of cascaded convolutional neural networks including at least a first convolutional neural network (CNN) and a second CNN;
providing the content item to the first CNN as input, the first CNN including at least one convolutional layer, pooling layer, and fully-connected layer, wherein an output of the first CNN includes data describing at least one region of interest in the content item and at least one first concept corresponding to the region of interest; and
providing the output of the first CNN to the second CNN as input, the second CNN including at least one convolutional layer, pooling layer, and fully-connected layer, wherein an output of the second CNN includes data describing at least one second concept corresponding to the region of interest, the second concept being more accurate than the first concept.

17. The non-transitory computer-readable storage medium of claim 16, wherein the computing system further performs:
causing the first CNN to be trained using at least a set of annotated training examples, wherein a training example includes a content item and at least one label for the content item that identifies (i) a concept captured in the content item and (ii) a location corresponding to the concept in the content item.

18. The non-transitory computer-readable storage medium of claim 17, wherein the computing system further performs:
causing the second CNN to be trained using at least some outputs that were produced by the first CNN.

19. The non-transitory computer-readable storage medium of claim 16, wherein providing the output of the first CNN to the second CNN as input further causes the computing system to perform:
providing a zoomed-in portion of the at least one region of interest to the second CNN.

20. The non-transitory computer-readable storage medium of claim 16, wherein the output of the second CNN includes data describing at least one second region of interest in the content item and at least one concept corresponding to the second region of interest.
